(19) United States
(12) Patent Application Publication
(10) Pub. No.: US 2006/0141952 A1
(43) Pub. Date: Jun. 29, 2006

(54) Multi-mode modulator and transmitter

(75) Inventors: William Kung, Waterloo (CA); Christopher Eugene Snyder, Waterloo (CA)

Correspondence Address: OBLON, SPIVAK, MCCLELLAND, MAIER & NEUSTADT, P.C., 1940 DUKE STREET, ALEXANDRIA, VA, 22314, US

(73) Assignee: SiRiFIC Wireless Corporation, Waterloo (CA)

(21) Appl. No.: 10/541,243

(22) PCT Filed: Jan. 6, 2004
(86) PCT No.: PCT/CA04/00014

§ 371 Date: Jan. 17, 2006

Related U.S. Application Data
(60) Provisional application No. 60/438,202, filed on Jan. 6, 2003.

(30) Foreign Application Priority Data
Jan. 6, 2003 (CA) 2,415,668

(51) Int. Cl. H04B 1/02; H04B 1/66

(52) U.S. Cl. 455/102

(57) ABSTRACT

The present invention relates generally to communications, and more specifically to a method and apparatus of modulating baseband and RF (radio frequency) signals. A modulator topology is disclosed in which an input signal x(t) is up-converted to an output signal y(t), either by mixing it with two mixing signals φ1 and φ2 (“pseudo-direct conversion” mode), or by mixing it with only one mixing signal φ2 (“direct-conversion” mode). In pseudo-direct modulation mode, the φ1 and φ2 mixing signals emulate a local oscillator signal; the product φ1*φ2 has significant power at the frequency of a local oscillator signal being emulated, but neither φ1 nor φ2 have significant power at the frequency of the input signal x(t), the LO signal being emulated, or the output signal φ1 φ2 x(t).

The present invention relates generally to communications, and more specifically to a method and apparatus of modulating baseband and RF (radio frequency) signals. The preferred embodiment of the invention satisfies the need for an inexpensive, high-performance, fully-integrable, multi-standard transmitter.

### BACKGROUND OF THE INVENTION

Many communication systems modulate electromagnetic signals from baseband to higher frequencies for transmission, and subsequently demodulate those high frequencies back to their original frequency band when they reach the receiver. The original (or baseband) signal may be, for example: data, voice or video. These baseband signals may be produced by transducers such as microphones or video cameras, be computer generated, or transferred from an electronic storage device. In general, the high frequencies provide longer range and higher capacity channels than baseband signals, and because high frequency signals can effectively propagate through the air, they can be used for wireless transmissions as well as hard wired or wave guided channels.

All of these signals are generally referred to as RF signals, which are electromagnetic signals; that is, waveforms with electrical and magnetic properties within the electromagnetic spectrum normally associated with radio wave propagation.

Wired communication systems which employ such modulation and demodulation techniques include computer communication systems such as local area networks (LANs), point-to-point communications, and wide area networks (WANs) such as the Internet. These networks generally communicate data signals over electrically conductive or optical fibre channels. Wireless communication systems which may employ modulation and demodulation include those for public broadcasting such as AM and FM radio, and UHF and VHF television. Private communication systems may include cellular telephone networks, personal paging devices, HF radio systems used by taxi services, microwave backbone networks, interconnected appliances under the Bluetooth standard, and satellite communications. Other wired and wireless systems which use RF modulation and demodulation would be known to those skilled in the art.

There is currently a great desire to provide wireless devices which operate under multiple standards. This would allow, for example, cellular telephones to be truly mobile even when the user travels from one country which uses the GSM (Global System for Mobile Communication) standard to another country which uses the CDMA (Code Division Multiple Access) standard.

There is also a desire to provide such devices in a completely integrated form, in the interest of providing smaller, lighter devices which are less expensive, and which consume less power. Discrete electronic components such as off-chip filters, are physically large, comparatively expensive and consume more power than integrated components.

Conventional, integrated transmitter architectures suffer from a variety of limitations in the context of realizing a single transmitter that is capable of operation across multiple standards (i.e. a multi-standard/multi-mode transmitter). A number of transmitter architectures have been proposed, but none of them are effective. These designs usually provide this functionality by means of multiple, independent signal paths—one signal path and set of components for each frequency standard and/or set of operating conditions. This is an expensive and physically bulky approach which suffers from all of the performance problems described above.

For example, indirect modulation is a proven architecture for single-mode transmission and has the advantages of high overall performance in terms of noise, linearity and power/gain control. However, this architecture is relatively costly to implement due to the need for IF and RF filters. As well, realization of a small and inexpensive multi-mode, multi-band transmitter is generally not possible using indirect modulation.

Indirect modulation transmitters use a two-step frequency translation method to convert a baseband signal or an RF signal to a higher frequency. FIG. 1 presents a block diagram of a typical indirect modulation transmitter 10. The mixers labelled 12 and 14 are used to translate the input signal Sin (generally a baseband signal, but could also be an RF signal) to a higher RF frequency (usually the carrier frequency of a signal being transmitted), which is labelled as output signal Sout. The balance of the components amplify the signal being processed and filter noise from it.

First, amplifier 22 buffers and amplifies the baseband signal, ensuring that it is at a level suitable to handle the subsequent processing. The amplified signal is then filtered by a low pass or band pass filter 24 to remove undesirable signals which may interfere. The filtered signal then enters mixer 12 which mixes the signal from filter 24 with a periodic signal generated by a local oscillator (LO1) 26. This translates the Sin signal to a higher frequency, known as the first intermediate frequency (IF1).

Generally, a mixer is a circuit or device that accepts as its input two different frequencies and presents at its output:
(a) a signal equal in frequency to the sum of the frequencies of the input signals;
(b) a signal equal in frequency to the difference between the frequencies of the input signals; and
(c) the original input frequencies.
   The typical embodiment of a mixer is a digital switch which may generate significantly more tones than stated above.

The IF1 signal is next filtered by a band pass filter 28 typically called a channel filter, which is centred around the IF1 frequency, thus filtering out the unwanted products of the first mixing processes; signals (a) and (c) above. This is necessary to prevent these signals from interfering with the desired signal when the second mixing process is performed.

The signal is then amplified by an intermediate frequency amplifier (IFA) 30, and is mixed with a second local oscillator signal using mixer 14 and local oscillator (LO2) 32. The second local oscillator LO2 32 generates a periodic signal which is tuned to modulate the IF1 signal to the desired transmission or carrier frequency. Thus, the signal coming from the output of 14 is now at desired transmission frequency. Noise is now filtered from the desired signal using a high pass filter or band pass filter 38, and the signal is amplified by amplifier 40, so that it can now be transmitted.

Note that the same process can be used to modulate or demodulate any electrical signal from one frequency to another.

The main problems with the in-direct conversion design are:
it requires expensive off-chip components, particularly filters 24, 28 and 38;
the off-chip components require design trade-offs that increase power consumption and reduce system gain;
image rejection is limited by the off-chip components, not by the target integration technology;
isolation from digital noise can be a problem; and
it is not fully integratable.

The filters 24, 28 and 38 used in indirect conversion systems must be high quality devices, so electronically tunable filters cannot be used. As well, the only way to use the indirect conversion system in a multi-standard/multi-frequency application is to use a separate set of off-chip filters for each frequency band. Clearly this is not an effective approach to the provision of a multi-standard/multi-frequency transmitter.

The continuing desire to implement low-cost, power efficient transmitters has proven especially challenging as the frequencies of interest in the wireless telecommunications industry (especially low-power cellular/micro-cellular voice/data personal communications systems) have risen above those used previously (approximately 900 MHz) into the spectrum above 1 GHz.

Thus, there is a need for a method and apparatus for signal modulation which addresses the problems above. It is desirable that this multi-standard/multi-frequency design be fully-integratable, inexpensive and high performance.

### SUMMARY OF THE INVENTION

It is therefore an object of the invention to provide a novel method and system of modulation and demodulation which obviates or mitigates at least one of the disadvantages of the prior art.

One aspect of the invention is defined as a circuit for modulating an input signal x(t) to an output signal y(t), the circuit comprising: a first mixer having an input for an RF signal, an input for a first mixing signal f1 and an output for a mixed signal based on the two input signals; a second mixer having an input for an RF signal, an input for a second mixing signal f2 and an output for a mixed signal based on the two input signals, the output providing the output signal y(t), and the output of the first mixer being connected to the RF input of the second mixer; a switch having one input and two outputs, the input for receiving the input signal x(t) and the two outputs being connected to separate ones of the RF signal inputs of the first mixer and the second mixer, whereby the switch can be selectively controlled to direct the input signal x(t) to the input of either the first mixer or the second mixer; a first signal generator, for generating a multi-tonal mixing signal φ1 and providing the first mixing signal to the first mixer; a second signal generator, for generating a mono-tonal mixing signal φ2 and providing the second mixing signal to the second mixer; and a control circuit for controlling the position of the switch and the signals generated by the first signal generator and the second generator, the control circuit having two modes: a first mode in which the input signal x(t) is fed to the second mixer, and the second signal generator is operable to generate a direct-conversion type oscillator signal; and a second mode in which the input signal x(t) is fed to the first mixer, and the first and second signal generators are controlled to generate a virtual local oscillator signal pair where φ1*φ2 has significant power at the frequency of the local oscillator signal being emulated, neither of the φ1 nor the φ2 having significant power at the carrier frequency of the input signal x(t) or the LO signal being emulated.

An alternative aspect of the invention is defined as a circuit for modulating an input signal x(t) to an output signal y(t), the circuit comprising: a first mixer having an input for an RF signal, an input for a first mixing signal f1 and an output for a mixed signal based on the two input signals; a second mixer having an input for an RF signal, an input for a second mixing signal f2 and an output for a mixed signal based on the two input signals, the output providing the output signal y(t), and the output of the first mixer being connected to the RF input of the second mixer; a first signal generator, for generating either a multi-tonal mixing signal φ1 or a constant value signal, and providing the first mixing signal to the first mixer; a second signal generator, for generating a mono-tonal mixing signal φ2 and providing the second mixing signal to the second mixer; and a control circuit for controlling the signals generated by the first signal generator and the second generator, the control circuit having two modes: a first mode in which the first signal generator is controlled to generate a constant value signal, and the second signal generator is controlled to generate a direct-conversion type oscillator signal; and a second mode in which the first and second signal generators are controlled to generate a virtual local oscillator signal pair where φ1*φ2 has significant power at the frequency of a local oscillator signal being emulated, and neither of the φ1 nor the φ2 having significant power at the frequency of the input signal x(t) or the LO signal being emulated.

### BRIEF DESCRIPTION OF THE DRAWINGS

These and other features of the invention will become more apparent from the following description in which reference is made to the appended drawings in which:

FIG. 1 presents a block diagram of a super-heterodyne modulation topology as known in the art;

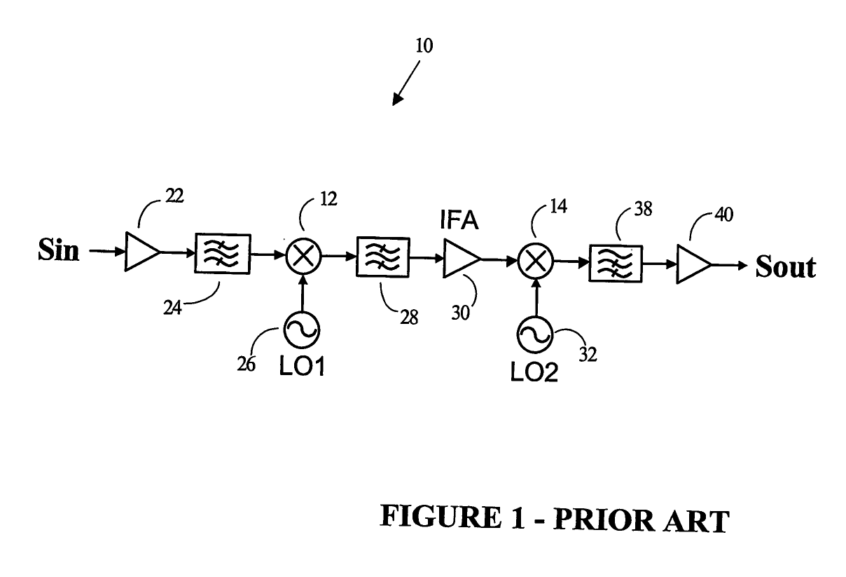

FIG. 2 presents a block diagram of a modulator topology in a broad embodiment of the invention;

FIG. 3 presents a timing diagram of a set of mixing signals in a broad embodiment of the invention;

FIG. 4 presents a block diagram of a differential modulator topology in an embodiment of the invention;

FIG. 5 presents a timing diagram of a set differential mixing signals plotted in amplitude against time, in an embodiment of the invention; and

FIG. 6 presents a block diagram of a differential modulator topology in an alternative embodiment of the invention.

### DETAILED DESCRIPTION OF THE INVENTION

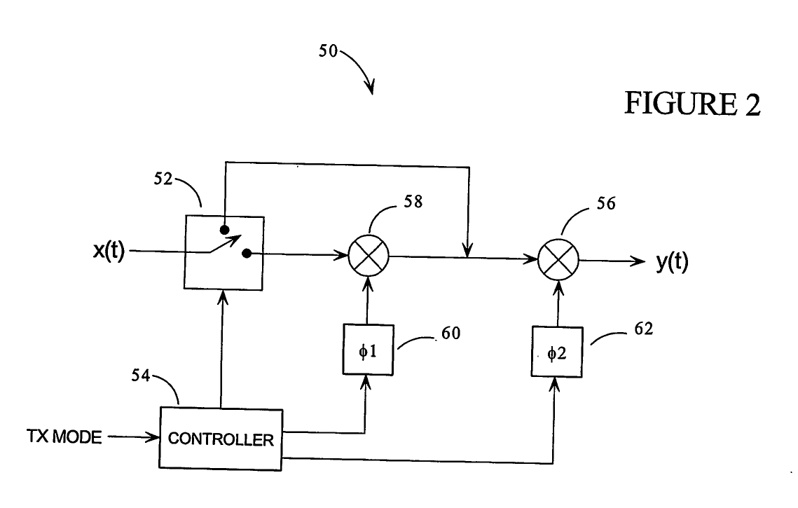

A circuit which addresses a number of the objects outlined above is presented as a block diagram in FIG. 2. This figure presents a modulator topology 50 in which an input signal x(t) is up-converted to an output signal y(t), either by mixing it with two mixing signals φ1 and φ2 (“pseudo-direct conversion” mode), or by mixing it with only one mixing signal φ2 (“direct-conversion” mode).

Direct-conversion transceivers perform up and down conversion in a single step, using one mixer and one local oscillator. In the case of up-conversion of a signal from baseband to a carrier frequency, this requires a local oscillator signal φ2 with a frequency equal to that of the desired carrier frequency.

As will be described, these two mixing signals φ1 and φ2, use for pseudo-direct conversion are very different from mixing signals used in normal two-step conversion topologies (such as indirect conversion or superheterodyne topologies). The main difference is that two pseudo-direct conversion mixing signals are used to emulate a single direct-conversion mixing signal, without the usual short comings of direct-conversion.

Direct modulation has the advantages of simplified frequency planning, low cost implementation, and compatibility with multiple modulation formats. However, it suffers from limited power and gain control (while maintaining satisfactory performance) in a single, integrated circuit.

The proposed transmitter exploits the advantages of both direct modulation and pseudo-direct modulation. At high output/high gain control settings, the transmitter is configured as a direct modulator. At low output flow gain control settings, the transmitter is configured as a pseudo-direct modulator. The net result is an integrated, configurable, multi-mode transmitter. Virtues of the novel transmitter are simplified frequency planning, low cost of implementation, compatibility with multiple modulation formats, and wide output power/gain control range.

As noted, an exemplary topology of the invention is presented in the block diagram of FIG. 2. In the interest of simplicity, this circuit is shown without differential signalling or in-phase and quadrature signal components, though it could easily be adapted for such use.

In this topology, the incoming signal x(t), is fed to a switch 52 which is controlled by controller 54. The controller 54, is used to select the transmitter mode of operation between direct modulation and pseudo-direct modulation. For operation as a direct modulator, switch 52 connects the incoming signal x(t) to the input of mixer 56. For pseudo-direct modulation, switch 52 connects the incoming signal x(t) to the input of mixer 58.

The controller 54 also controls the operation of the two modulation signal generators φ1 60 and φ2 62.

In a typical application, the controller 54 sets the operating mode to direct modulation at higher output power/gain control settings and sets the operating mode to pseudo-direct modulation at lower output power/gain control settings. In direct modulation mode, only the φ2 signal generator 62 is used, while in pseudo-direct modulation mode, both the φ1 and φ2 generators 60, 62 are required.

The mode of controller 54 is controlled by an input signal labelled “TXMODE”. The TXMODE signal could be generated in a number of ways, but typically will be generated by a digital signal processor (DSP) or an ASIC (application specific integrated circuit).

In direct modulation mode, controller 54 will set the frequency of mixing signal φ2, generated by the φ2 signal generator 62 to be at the desired carrier frequency.

In pseudo-direct modulation mode, controller 54 will coordinate the φ1 and φ2 mixing signal generators 60, 62 to generate a pair of “virtual local oscillator” (VLO) signals φ1 and φ2. These mixing signals φ1 and φ2 are generally referred to herein as VLO signals because they emulate a local oscillator signal; the product φ1*φ2 has significant power at the frequency of a local oscillator signal being emulated. However, neither φ1 nor φ2 have significant power at the frequency of the input signal x(t), the LO signal being emulated, or the output signal φ1 φ2 x(t). Mixing signals with such characteristics greatly resolve the problem of self-mixing because the VLO signals simply do not have significant power at frequencies that will interfere with the output signal.

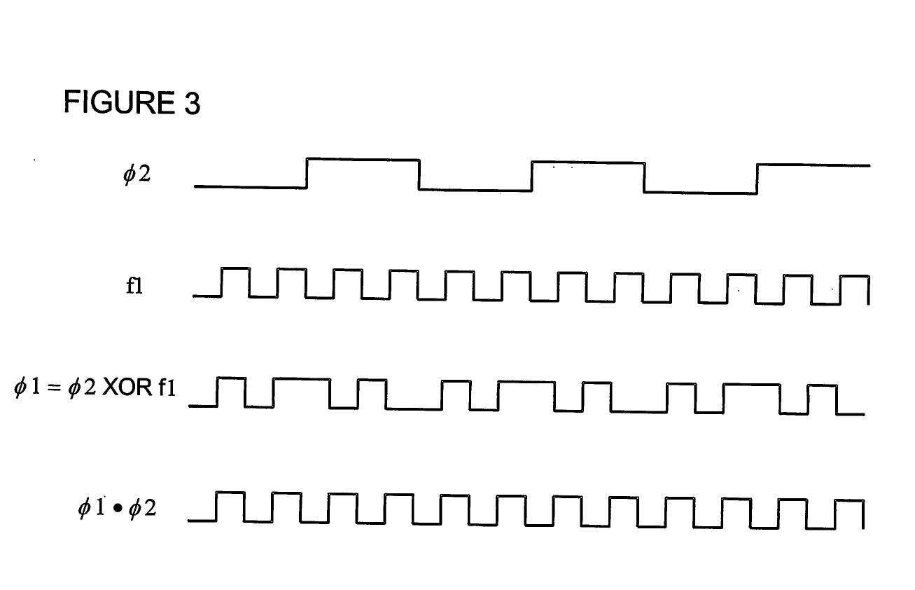

These VLO signals are described in greater detail hereinafter, but an exemplary pair of φ1 and φ2 mixing signals is presented in FIG. 3, plotted in amplitude versus time. As shown in FIG. 3, one of these mixing signals may be a “multi-tonal” signal (multi-tonal, or non-mono-tonal, refers to a signal having more than one fundamental frequency tone. Mono-tonal signals have one fundamental frequency tone and may have other tones that are harmonically related to the fundamental tone), while the other mixing signal may be a mono-tonal signal. Both signals may also be multi-tonal.

The oscillator signal f1 used to generate φ1 in FIG. 3, is operating at a frequency that is four times that of φ2. Thus, φ1 can be generated from the simple logical operation of φ2 XOR f1. As well, the product of these two mixing signals, φ1*φ2, is clearly equal to the desired LO signal. Thus, the output of the pseudo-direct conversion topology y(t)=φ1 φ2 x(t) will be equal to the output of a hypothetical LO*x(t) down conversion.

However, it is important to note that at no point in the operation of the circuit is an actual “φ1*φ2” signal ever generated and if it is, only an insignificant amount is generated. The mixers 56, 58 receive separate φ1 and φ2 signals, and mix them with the input signal x(t) using different physical components. Hence, there is no LO signal which may leak into the circuit.

Looking at one cycle of these mixing signals from FIG. 3 the generation of the φ1*φ2 signal is clear:

| φ2 | f1 | φ1 = φ2 XOR f1 | φ1 * φ2 |
|---|---|---|---|
| LO | LO | LO | LO |
| LO | HI | HI | HI |
| LO | LO | LO | LO |
| LO | HI | HI | HI |
| HI | LO | HI | LO |
| HI | HI | LO | HI |
| HI | LO | HI | LO |
| HI | HI | LO | HI |

Clearly, the two mixing signals φ1 and φ2 in FIG. 3 satisfy the criteria for effective VLO signals.

The only problem with this embodiment is that f1 does have power at the frequency of the LO signal being emulated, thus care must be taken to isolate it and to minimize any self-mixing that it might cause. This could be done using standard analogue design and layout techniques, as known in the art. These techniques could include, for example:
1. placing the oscillator on-chip. If the oscillator was off-chip, integrated circuit pins and tracks of the printed circuit board might serve as antennas which radiate the oscillator signal; or
2. using an oscillator which operates at a higher frequency than f1, and down converting it using a divider. In the embodiments described hereinafter, a regenerative divider is used, which is particularly effective.
   VLO mixing signals and methods of generating them, are discussed in greater detail hereinafter, and in many of the Applicant's co-pending patent applications.

Note that particular design parameters for the two mixers 56 and 58 would be clear to one skilled in the art, having the typical properties of an associated noise figure, linearity response, and conversion gain. The selection and design of these mixers would follow the standards known in the art. The design of other components would also be clear to one skilled in the art from the teachings herein.

Though FIG. 2 implies that various elements are implemented in analogue form, they can also be implemented in digital form. The mixing signals are typically presented herein in terms of binary 1s and 0s, however, bipolar waveforms, ±1, may also be used. Bipolar waveforms are typically used in spread spectrum applications because they use commutating mixers which periodically invert their inputs in step with a local control signal (this inverting process is distinct from mixing a signal with a local oscillator directly).

The topology of the invention allows an input signal x(t) to be down-converted effectively, using a completely integratable circuit. It is also particularly convenient when applied to the development of multi-standard/multi-frequency devices because no filters are required, and because the mixing signals can be generated and varied so easily. This advantage will become clearer from the description which follows.

Other advantages of the invention will also become clear from the other embodiments of the invention described hereinafter.

A number of other embodiments of the invention will now be described.

### DESCRIPTION OF PREFERRED EMBODIMENTS OF THE INVENTION

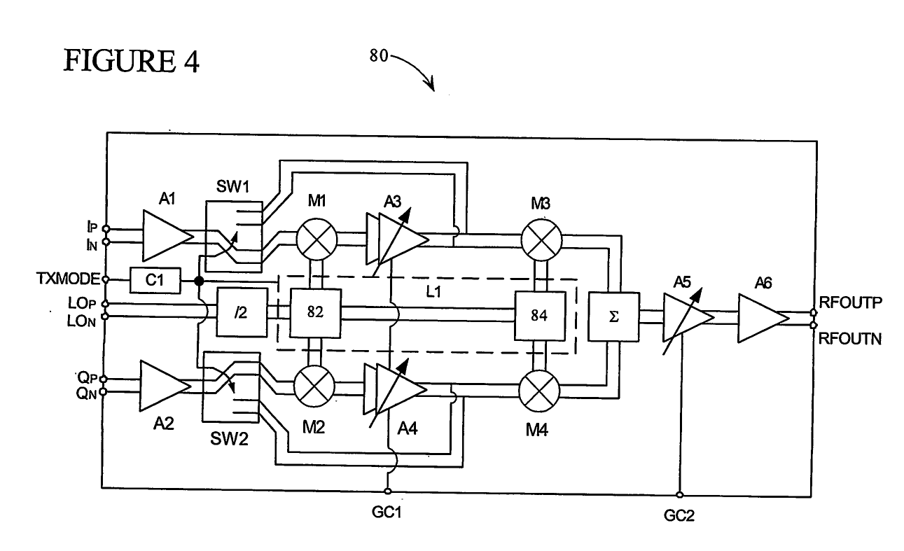

The preferred embodiment of the invention is presented as a block diagram in FIG. 4. This topology is much the same as that of FIG. 2, the primary differences being that the topology of FIG. 4 handles in-phase (I) and quadrature (Q) signal components, and all of the signals are handled in differential mode. The topology of FIG. 4 also includes a number of variable-gain amplifiers, which provide greater flexibility and improved performance, particularly in multi-standard/multi-frequency applications.

Differential signals are signals having positive and negative potentials with respect to ground, rather than a signal with only a single potential with respect to ground. The use of a differential architecture results in a stronger output signal that is more immune to common mode noise than the architecture presented in FIGS. 2 and 3. If, for example, environmental noise imposes a noise signal onto the input x(t) of FIG. 2, then this noise signal will propagate through the circuit. However, if this environment noise is imposed equally on the IP and IN signal inputs of the differential circuit, then the net effect will be zero. Differential amplifiers, mixers and switches are well known in the art.

The topology 80 of FIG. 4 is also designed to handle in-phase (I) and quadrature (Q) signal components. In many modulation schemes, it is necessary to modulate or demodulate both in-phase (I) and quadrature (Q) components of the input signal; simply put, these are signal components which are 90 degrees out of phase from one another.

With separate I and Q signal components, separate I and Q mixing signals must be generated. In the case of the pseudo-direct conversion, four mixing signals would have to be generated: φ1I which is 90 degrees out of phase with φ1Q; and φ2I which is 90 degrees out of phase with φ2Q. The pairing of signals φ1I and φ2I must meet the functional selection criteria for VLO mixing signals listed above, as must the signal pairing of φ1Q and φ2Q.

Design of components to generate such φ1I, φ1 Q, φ2I and φ2Q signals would be clear to one skilled in the art from the description herein. As well, additional details on the generation of such signals are available in the co-pending patent applications filed under PCT International Application Serial Nos. PCT/CA00/00994, PCT/CA00/00995 and PCT/CA00/00996.

Returning to the block diagram of FIG. 4, differential signalling is used throughout, generally represented by P and N labels. The in-phase and quadrature components of the input signal are identified as I and Q respectively, and are handled and modulated in two separate signal channels and then merged into a combined signal after modulation has been completed.

The differential amplifiers A1 and A2 of FIG. 4 buffer and amplify the incoming pairs of baseband signals, IP, IN and QP, QN. IP is the positive, in-phase component of the incoming signal and IN is the negative, in-phase component of the incoming signal. Similarly, QP is the positive, quadrature-phase component of the incoming signal and QN is the negative, quadrature-phase component of the incoming signal. Note that these two amplifiers A1 and A2 are used in both direct modulation and pseudo-direct modulation modes of operation.

The two pairs of signals now pass to differential switches SW1 and SW2. Switches SW1 and SW2 are controlled via circuit block C1, and are used to select the transmitter mode of operation between direct modulation and pseudo-direct modulation. For operation as a direct modulator, switches SW1 and SW2 connect the outputs of amplifiers A1 and A2, to the inputs of mixers M3 and M4 respectively. For pseudo-direct modulation, switches SW1 and SW2 connect the outputs of amplifiers A1 and A2, to the inputs of mixers M1 and M2 respectively.

Circuit block C1 selects the transmitter mode of operation between direct modulation and pseudo-direct modulation via control of switches SW1 and SW2, and the modulation signal generators 82 and 84 generators in circuit block L1. In a typical application, the circuit block C1 sets the operating mode to direct modulation at higher output power/gain control settings and sets the operating mode to pseudo-direct modulation at lower output power/gain control settings.

In direct conversion mode, only signal generator 84 of circuit block L1 is used, while in pseudo-direct conversion mode, both the 82 and 84 generators are required. As noted above, in direct conversion mode signal generator 84 will generate a pair of I and Q signal components for a single φ2 modulating signal (at the carrier frequency). In pseudo-direct conversion mode, two mixing signals would have to be generated by signal generator 82, φ1I and φ1Q; and two mixing signals would have to be generated by signal generator 84, φ2I and φ2Q.

The incoming differential local oscillator signals LOP and LON are used by the circuit block L1 to generate the mixing signals. These local oscillator signals are preferably at a frequency which is a multiple or fraction of the actual mixing signals being used. This is desirable to minimize LO leakage into the signal path, which can interfere with useful data. In the circuit of FIG. 4, signals LOP and LON are at twice the frequency of the actual LO being used internally, and these signals are divided by 2, using circuit block/2.

In this embodiment of the invention, the mode of circuit block C1 is controlled by an input signal labelled “TXMODE”. The TXMODE signal could be generated in a number of ways, but typically will be generated by a digital signal processor (DSP) or an ASIC (application specific integrated circuit).

Differential mixers M1 and M2 are used in the pseudo-direct modulation mode of operation. They simply mix the baseband input signals using the differential φ1 signals described herein above. The output of mixers M1 and M2 are therefore pseudo-IF signals.

Differential amplifiers A3 and A4 are then used in the pseudo-direct modulation mode of operation, to vary the signal gain and power of the pseudo-IF signals. The degree of amplification is controlled via the external control signal GC1 to optimise the operation of the circuit in pseudo-direct modulation mode.

Differential mixers M3 and M4 are used in both direct modulation and pseudo-direct modulation modes of operation, mixing the signals that they receive, to the final RF frequency. If the circuit is in the direction modulation mode, then the circuit block C1 will cause the mixing signals φ2I and φ2Q to simply be oscillator signals at the desired carrier frequency. If the circuit is in pseudo-direct modulation mode, then the circuit block C1 will control the signal generators 82 and 84 to generate complementary pairs of VLO mixing signals φ1I and φ1Q, and φ2I and φ2Q.

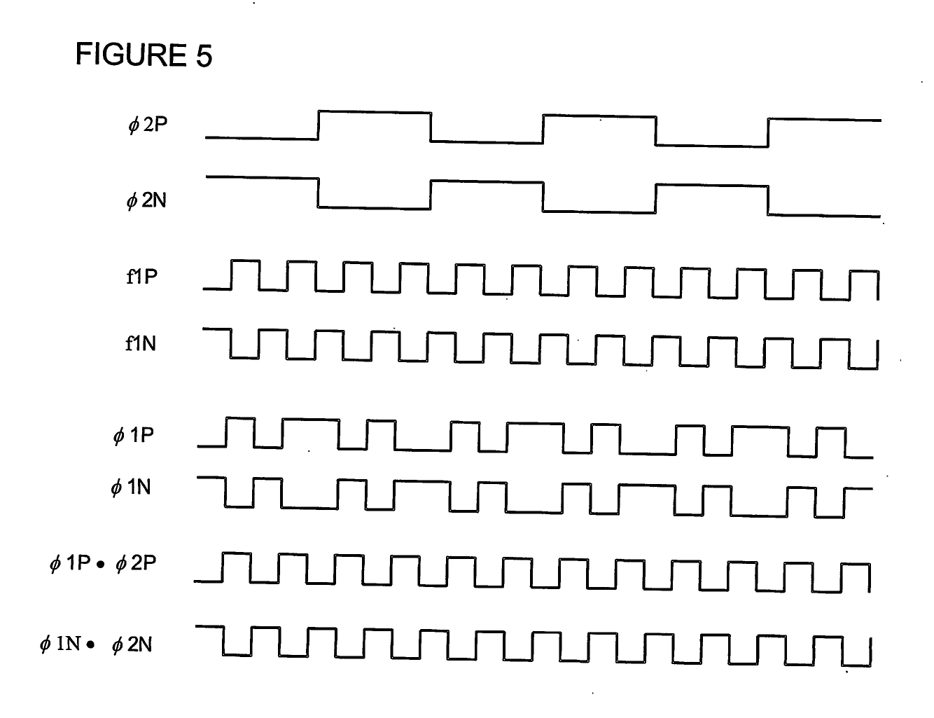

Because the components of FIG. 4 are all differential, these mixing signals must also be differential. A method of generating an exemplary pair of differential mixing signals φ1P/φ1N and φ2P/φ2N is shown in FIG. 5. The signals in FIG. 5 are the same as those of FIG. 3, except that complementary P and N components are required. That is, a differential oscillator signal f1P/f1N runs at four times the frequency of the differential mixing signal φ2P/φ2N. This signal f1P/f1N can generate the differential mixing signal φ1P/φ1N, simply using the logical operation of φ2 XOR f1. The products of the mixing signals, φ1P*φ2P and φ1N*φ2N, are clearly equal to the LO signal being emulated. The generation of I and Q mixing signals follows in the same way.

Regardless of the operating mode, the in-phase and quadrature signal paths are then merged using the differential summer Σ. The differential, variable gain amplifier A5 is then used to vary the signal gain and power at RF via the external control signal GC2. Finally, differential amplifier A6 is used to buffer and amplify the resultant modulated RF signal.

Note, of course, that the summer Σ, variable gain amplifier A5 and amplifier A6 are used in both the direct modulation and pseudo-direct modulation modes of operation.

### ALTERNATIVE EMBODIMENT OF THE INVENTION

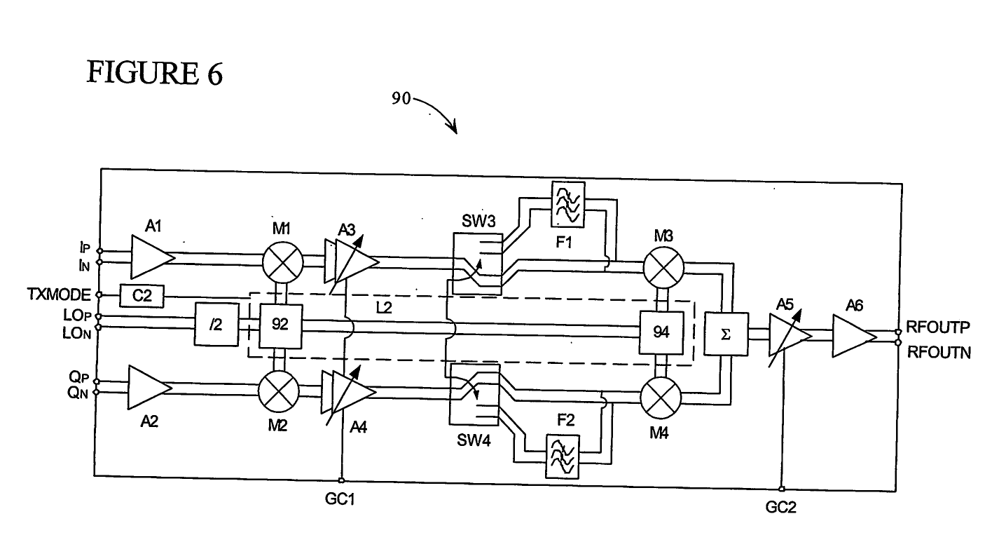

An alternative embodiment of the invention is presented in the block diagram of FIG. 6.

This circuit is almost the same as that of FIG. 4, all of the amplifiers, mixers and summers operating in the same way. As well, this circuit also operates in two modes: direction conversion and pseudo-direct conversion. The most obvious difference between the two circuits is that switches SW1 and SW2 have been removed, and replaced with two switches SW3 and SW4, which were placed between differential amplifiers A3, A4 and differential mixers M3, M4. These two switches SW3, SW4 are used to place the new differential filters F1, F2 in or out of the circuit. As will be explained, the new low pass filters F1, F2 are used while the circuit is in direction conversion mode.

Though it is not apparent from the block diagrams, the operation of circuit block C2, circuit block L2, and differential modulation signal generators 92 and 94, are also quite different from the operation of the corresponding components in FIG. 4.

As noted above, the circuit of FIG. 6 operates in one of two modes, as controlled by the “TX MODE” input to circuit block C2. When the circuit is in direct conversion mode:
1. circuit block C2 directs the modulation signal generator 92 to generate constant value signal (i.e. a DC signal). The output of differential mixers M1, M2 is the product of its input signals so (input x constant) will result in an output at the same frequency as the input, making the two differential mixers M1, M2 act simply as linear gain elements with no frequency translation;
2. circuit block C2 toggles the two switches SW3, SW4 to place the low pass filters F1, F2 into the circuit. This is done (when required) to improve noise and spurious performance in direct modulation mode. Of course, the filters may not be necessary in all cases, and other manners of filters may also be substituted, depending on system requirements; and
3. circuit block C2 directs the modulation signal generator 94 to generate normal direct-conversion mixing signals, which are fed to differential mixers M3, M4.
   In pseudo-direct conversion mode:
1. circuit block C2 directs the modulation signal generators 92, 94 to generate VLO mixing signals as described above; and
2. circuit block C2 toggles the two switches SW3, SW4 to place the low pass filters F1, F2 out the circuit.

Apart from these changes, this circuit uses basically the same components as that of FIG. 4, and operates in much the same manner.

Virtual Local Oscillator Signals

An exemplary set of VLO signals were described hereinabove. The purpose of this section is to present VLO signals in a more general way, as any number of VLO signals could be generated with which the invention could be implemented.

Aperiodic or time-varying mixing signals offer advantages over previously used mono-tonal oscillator signals. A given pair of these virtual local oscillator (VLO) signals φ1 and φ2 have the properties that:
1. their product emulates a local oscillator (LO) signal that has significant power at the frequency necessary to translate the input signal x(t) to the desired output frequency. For example, to translate the input signal x(t) to baseband in a receiver, φ1(t)*φ2(t) must have a frequency component at the carrier frequency of x(t); and
2. one of either φ1 and φ2, has minimal power around the frequency of the mixer pair output φ1(t)*φ2(t)*x(t), while the other has minimal power around the centre frequency, f_{RF}, of the input signal x(t). “Minimal power” means that the power should be low enough that it does not seriously degrade the performance of the RF chain in the context of the particular application.

For example, if the mixer pair is demodulating the input signal x(t) to baseband in a receiver, it is preferable that one of either φ1 and φ2 has minimal power around DC.

As a result, the desired demodulation is affected, but there is little or no LO signal to leak into the signal path and appear at the output.

As noted above, mixing two signals together generates an output with:
(a) a signal equal in frequency to the sum of the frequencies of the input signals;
(b) a signal equal in frequency to the difference between the frequencies of the input signals; and
(c) the original input frequencies.
   Thus, direct conversion receivers known in the art must mix the input signal x(t) with a LO signal at the carrier frequency of the input signal x(t). If the LO signal of a direct conversion receiver leaks into the signal path, it will also be demodulated to baseband along with the input signal x(t), causing interference. The invention does not use an LO signal, so leakage does not generate a signal at the baseband output φ1(t)*φ2(t)*x(t).

Any signal component at the frequency of the input signal x(t) or the output signal φ1(t)*φ2(t)*x(t), in either of the mixing signals φ1 and φ2, is suppressed or eliminated by the other mixing signal. For example, if the mixing signal φ2 has some amount of power within the bandwidth of the up-converted RF (output) signal, and it leaks into the signal path, then if will be suppressed by the φ1 mixing signal which has minimal power within the bandwidth of the up-converted RF (output) signal. This complementary mixing suppresses interference from the mixing signals φ1 and φ2.

As noted above, current receiver and transmitter technologies have several problems. Direct-conversion transceivers, for example, suffer from LO leakage and 1/f noise problems which limit their capabilities, while heterodyne transceivers require image-rejection techniques which are difficult to implement on-chip with high levels of performance.

The problems of image-rejection, LO leakage and 1/f noise in highly integrated transceivers can be overcome by using the complementary VLO signals. These signals are complementary in that one of the φ1 and φ2 signals has minimal power around the frequency of the output signal y(t) (which is around DC if conversion is to baseband), and the other has minimal power around the centre frequency, f_{RF}, of the input signal x(t).

These signals φ1 and φ2 can, in general, be:
1. random or pseudo-random, periodic functions of time;
2. analogue or digital waveforms;
3. constructed using conventional or non-conventional bipolar waves;
4. averaging to zero;
5. amplitude modulated; and
6. generated in a number of manners including:
   a. being stored in memory and clocked out;
   b. being generated using digital blocks;
   c. being generated using noise shaping elements (e.g. delta-sigma elements); or
   d. being constructed using PN sequences with additional bits inserted so they comply to the above conditions.

It would be clear to one skilled in the art that virtual LO signals may be generated which provide the benefits of the invention to greater or lesser degrees. While it is possible in certain circumstances to have almost no LO leakage, it may be acceptable in other circumstances to incorporate virtual LO signals which still allow a degree of LO leakage.

Virtual local oscillator signals may also be generated in different forms, such as using three or more complementary signals rather than the two mixing signals shown above. These and other variations are described in the following co-pending patent applications:
1. PCT International Application Serial No. PCT/CA00/00995 Filed Sep. 1, 2000, titled: “Improved Method And Apparatus For Up-Conversion Of Radio Frequency (RF) Signals”;
2. PCT International Application Serial No. PCT/CA00/00994 Filed Sep. 1, 2000, titled: “Improved Method And Apparatus For Down-Conversion Of Radio Frequency (RF) Signals”; and
3. PCT International Application Serial No. PCT/CA00/00996 Filed Sep. 1, 2000, titled: “Improved Method And Apparatus For Up-And-Down-Conversion Of Radio Frequency (RF) Signals”.
   Advantages of the Invention

The invention provides many advantages over other up-convertors known in the art. To begin with, it offers:
1. minimal imaging problems;
2. minimal leakage of a local oscillator (LO) signal into the RF output band;
3. removes the necessity of having a second LO as required by super-heterodyne circuits, and various (often external) filters; and
4. has a higher level of integration as the components it does require are easily placed on an integrated circuit. For example, no large capacitors or sophisticated filters are required.

A high level of integration results in decreased IC (integrated circuit) pin counts, decreased signal power loss, decreased IC power requirements, improved SNR (signal to noise ratio), improved NF (noise factor), and decreased manufacturing costs and complexity.

The design of the invention also makes the production of inexpensive, configurable, multi-standard/multi-frequency communications transmitters and receivers a reality. As noted in the Background herein above, multiple transmitters had to be designed to support multiple modes (standards). This resulted in high cost and large physical size. In contrast, the invention provides a topology that is extremely flexible and configurable. The oscillator signals can easily be changed electronically, as can the degree of gain from the variable-gain amplifiers A3, A4 and A5.

The benefits of the invention are most apparent when it is implemented within a single-chip design, eliminating the extra cost of interconnecting semiconductor integrated circuit devices, reducing the physical space they require and reducing the overall power consumption. Increasing levels of integration have been the driving impetus towards lower cost, higher volume, higher reliability and lower power consumer electronics since the inception of the integrated circuit. This invention will enable communications devices to follow the same integration route that other consumer electronic products have benefited from.

Other Options and Alternatives

A number of variations can be made to the topology of the invention including the following:
1. the invention can be implement using bipolar technology, CMOS technology, BiCMOS technology, or another semiconductor technology including, but not limited to Silicon/Germanium (SiGe), Germanium (Ge), Gallium Arsenide (GaAs), and Silicon on Sapphire (SOS);
2. mixing signals can be generated in many ways, for example, using a voltage controlled oscillator (VCO). Having a VCO at the frequency of the incoming signal can allow self-mixing to occur because the tracks of the printed circuit board (PCB) and pins of integrated circuits act as antennas for the LO signal to radiate. Using a VCO at a different frequency than the incoming signal x(t), and placing a frequency divider or multiplier on chip, minimizes the possibility of self-mixing;
3. control circuit C1, and control signals GC1 and GC2 may be merged into a single circuit that controls output power/gain and mode of operation;
4. the invention may be applied to various communication protocols and formats including: amplitude modulation (AM), frequency modulation (FM), frequency shift keying (FSK), phase shift keying (PSK), cellular telephone systems including analogue and digital systems such as code division multiple access (CDMA), time division multiple access (TDMA) and frequency division multiple access (FDMA); and
5. the mixers used in the topology of the invention could either be passive or active. Active mixers are distinct from passive mixers in a number of ways:
   a. they provide conversion gain. Thus, an active mixer can replace the combination of a low noise amplifier and a passive mixer;
   b. active mixers provide better isolation between the input and output ports because of the impedance of the active components; and
   c. active mixers allow a lower powered mixing signal to be used.

### CONCLUSIONS

It will be apparent to those skilled in the art that the invention can be extended to cope with more than two or three standards, and to allow for more biasing conditions than those in the above description.

The electrical circuits of the invention may be described by computer software code in a simulation language, or hardware development language used to fabricate integrated circuits. This computer software code may be stored in a variety of formats on various electronic memory media including computer diskettes, CD-ROM, Random Access Memory (RAM) and Read Only Memory (ROM). As well, electronic signals representing such computer software code may also be transmitted via a communication network.

Clearly, such computer software code may also be integrated with the code of other programs, implemented as a core or subroutine by external program calls, or by other techniques known in the art.

The embodiments of the invention may be implemented on various families of integrated circuit technologies using digital signal processors (DSPs), microcontrollers, microprocessors, field programmable gate arrays (FPGAs), or discrete components. Such implementations would be clear to one skilled in the art.

The invention may be applied to such applications as wired communication systems include computer communication systems such as local area networks (LANs), point to point signalling, and wide area networks (WANs) such as the Internet, using electrical or optical fibre cable systems. As well, wireless communication systems may include those for public broadcasting such as AM and FM radio, and UHF and VHF television; or those for private communication such as cellular telephones, personal paging devices, wireless local loops, monitoring of homes by utility companies, cordless telephones including the digital cordless European telecommunication (DECT) standard, mobile radio systems, GSM and AMPS cellular telephones, microwave backbone networks, interconnected appliances under the Bluetooth standard, and satellite communications.

While particular embodiments of the present invention have been shown and described, it is clear that changes and modifications may be made to such embodiments without departing from the true scope and spirit of the invention.

What is claimed is:

1. A circuit for modulating an input signal x(t) to an output signal y(t), said circuit comprising:
a first mixer having an input for an RF signal, an input for a first mixing signal f1 and an output for a mixed signal based on said two input signals;
a second mixer having an input for an RF signal, an input for a second mixing signal f2 and an output for a mixed signal based on said two input signals, said output providing said output signal y(t), and said output of said first mixer being connected to said RF input of said second mixer;
a switch having one input and two outputs, said input for receiving said input signal x(t) and said two outputs being connected to separate ones of said RF signal inputs of said first mixer and said second mixer, whereby said switch can be selectively controlled to direct said input signal x(t) to the input of either said first mixer or said second mixer;
a first signal generator, for generating a multi-tonal mixing signal φ1 and providing said first mixing signal to said first mixer;
a second signal generator, for generating a mono-tonal mixing signal φ2 and providing said second mixing signal to said second mixer; and
a control circuit for controlling the position of said switch and the signals generated by said first signal generator and said second generator, said control circuit having two modes:
a first mode in which said switch is positioned to feed said input signal x(t) to said second mixer, and said second signal generator is operable to generate a direct-conversion type oscillator signal; and
a second mode in which said switch is positioned to feed said input signal x(t) to said first mixer, and said first and second signal generators are controlled to generate a virtual local oscillator signal pair where φ1*φ2 has significant power at the frequency of a local oscillator signal being emulated, and neither of said φ1 nor said φ2 having significant power at the frequency of said input signal x(t) or said LO signal being emulated.

2. The circuit of claim 1, further comprising a variable gain amplifier after said second mixer.

3. The circuit of claim 1, further comprising a variable gain amplifier after said first mixer.

4. The circuit of claim 1, further comprising an amplifier prior to said switch.

5. The circuit of claim 1, further comprising an amplifier after said second mixer.

6. The circuit of claim 1, wherein each of said amplifiers and each of said mixers is a differential device.

7. A transmitter comprising:
two modulation channels like that of claim 1, a first channel for modulating an in-phase input signal, and a second channel for modulating a quadrature input signal; and
a summer to combine the outputs of said first channel and said second channel.

8. The transmitter of claim 7, further comprising a variable gain amplifier after said summer.

9. The transmitter of claim 7, further comprising an amplifier after said summer.

10. The circuit of claim 7, wherein each of said amplifiers and each of said mixers is a differential device.

11. A circuit for modulating an input signal x(t) to an output signal y(t), said circuit comprising:
a first mixer having an input for an RF signal, an input for a first mixing signal f1 and an output for a mixed signal based on said two input signals;
a second mixer having an input for an RF signal, an input for a second mixing signal f2 and an output for a mixed signal based on said two input signals, said output providing said output signal y(t), and said output of said first mixer being connected to said RF input of said second mixer;
a first signal generator, for generating either a multi-tonal mixing signal φ1 or a constant value signal, and providing said first mixing signal to said first mixer;
a second signal generator, for generating a mono-tonal mixing signal φ2 and providing said second mixing signal to said second mixer; and
a control circuit for controlling the signals generated by said first signal generator and said second generator, said control circuit having two modes:
a first mode in which said first signal generator is controlled to generate a constant value signal, and said second signal generator is controlled to generate a direct-conversion type oscillator signal; and
a second mode in which said first and second signal generators are controlled to generate a virtual local oscillator signal pair where φ1*φ2 has significant power at the frequency of a local oscillator signal being emulated, and neither of said φ1 nor said φ2 having significant power at the frequency of said input signal x(t) or said LO signal being emulated.

12. The circuit of claim 11, further comprising:
a filter; and
a switch which is operable to selectively place said filter inline between said first and said second mixers;
said switch being controlled by said control circuit.

13. The circuit of claim 11, further comprising a variable gain amplifier after said second mixer.

14. The circuit of claim 11, further comprising a variable gain amplifier after said first mixer.

15. The circuit of claim 11, further comprising an amplifier prior to said first mixer.

16. The circuit of claim 11, further comprising an amplifier after said second mixer.

17. The circuit of claim 11, wherein each of said amplifiers and each of said mixers is a differential device.

18. A transmitter comprising:
two modulation channels like that of claim 11, a first channel for modulating an in-phase input signal, and a second channel for modulating a quadrature input signal; and
a summer to combine the outputs of said first channel and said second channel.
